(19) United States
(12) Patent Application Publication
(10) Pub. No.: US 2026/0350497 A1
(43) Pub. Date: Nov. 5, 2026

(54) AGENTIC RECOMMENDATION INTELLIGENCE ENGINE FOR SKILLING

(71) Applicant: Pearson Education, Inc., Bloomington, MN (US)

(72) Inventors: Narayanan GOPALAKRISHNAN, Eden Prairie, MN (US); Kishore VAKATI, Shakopee, MN (US); Venkata Giridhar PINNAPU REDDY, Woodbury, MN (US)

(21) Appl. No.: 19/197,570

(22) Filed: May 2, 2025

(51) Int. Cl. G06Q 10/0631

(52) U.S. Cl. CPC G06Q 10/063112

(57) ABSTRACT

Systems and methods perform skilling in an agentic manner. Skilling operations include receiving, by an agentic artificial intelligence (AI) engine, a skilling request via a user interface operating in an existing application on a user device; querying, by the agentic AI engine, a plurality of dimensional agents based on the skilling request and a user data associated with a user of the user device, wherein respective ones of the plurality of dimensional agents correspond to different components of the skilling request; receiving, by the agentic AI engine, a plurality of dimensional content items from the plurality of dimensional agents; organizing, by the agentic AI engine, the plurality of dimensional content items into a personalized assessment; presenting, by the agentic AI engine, the personalized assessment via the user interface.

### TECHNICAL FIELD

This disclosure relates to the field of systems and methods for use in human-centered computing, and in particular examples to systems and methods configured to implement a comprehensive agentic framework that leverages artificial intelligence for workforce skilling.

### SUMMARY

According to one aspect of the present disclosure, an agentic skilling system is provided. The system comprises a memory; and at least one processor operatively connected to the memory and configured to perform operations comprising receiving, by an agentic artificial intelligence (AI) engine, a skilling request via a user interface operating in an existing application on a user device; querying, by the agentic AI engine, a plurality of dimensional agents based on the skilling request and a user data associated with a user of the user device, wherein respective ones of the plurality of dimensional agents correspond to different components of the skilling request; receiving, by the agentic AI engine, a plurality of dimensional content items from the plurality of dimensional agents; organizing, by the agentic AI engine, the plurality of dimensional content items into a personalized assessment; presenting, by the agentic AI engine, the personalized assessment via the user interface.

According to another aspect of the present disclosure, an agentic skilling method is provided. The method comprises receiving, by an agentic artificial intelligence (AI) engine, a skilling request via a user interface operating in an existing application on a user device; querying, by the agentic AI engine, a plurality of dimensional agents based on the skilling request and a user data associated with a user of the user device, wherein respective ones of the plurality of dimensional agents correspond to different components of the skilling request; receiving, by the agentic AI engine, a plurality of dimensional content items from the plurality of dimensional agents; organizing, by the agentic AI engine, the plurality of dimensional content items into a personalized assessment; presenting, by the agentic AI engine, the personalized assessment via the user interface.

The above features and advantages of the present invention will be better under-stood from the following detailed description taken in conjunction with the accompanying drawings.

### BRIEF DESCRIPTION OF THE DRAWINGS

FIG. 1 is a block diagram illustrating an example of a content delivery network.

FIG. 2 is a block diagram illustrating a computer server and computing environment within a content delivery network.

FIG. 3 is a block diagram illustrating an example of one or more data store servers within a content delivery network.

FIG. 4 is a block diagram illustrating an example of one or more content delivery servers within a content delivery network.

FIG. 5 is a block diagram illustrating an example of physical and logical components of a special-purpose computer device within a content delivery network.

FIG. 6 is a block diagram illustrating one example of a communication network.

FIG. 7A is a block diagram illustrating an example of an agentic skilling system.

FIG. 7B is a block diagram illustrating an example of an agentic skilling system.

FIG. 8 is a block diagram illustrating an example of communication flow within an agentic skilling system.

FIG. 9 is a block diagram illustrating an example of an agentic skilling method.

FIG. 10 is a block diagram illustrating an example of an agentic skilling method.

### DETAILED DESCRIPTION

The disclosed technology will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

In comparative skilling systems, content such as learning and assessments are often implemented as generalized, standalone solutions. These comparative examples suffer from low engagement for several reasons. For example, because the comparative examples are implemented in a standalone manner, a user must stop the flow of work (e.g., by opening a new application) in order to access the content. Moreover, the generalized nature of the comparative examples means that the content is not personalized to the user's particular needs or situation. This lack of personalization may mean that the content is not actually relevant to the user or not actually responsive to the user's problem, thus causing the user to seek the relevant information elsewhere (e.g., by initiating an Internet search). Comparative implementations, even if they implement comprehensive artificial intelligence (AI) models, suffer from hallucination and thus may fail to meet their goals of properly upskilling the user.

The systems, methods, and devices disclosed herein address the above and other needs using a methodology for developing a skilling framework that leverages AI models, such as large language models (LLMs), in an agentic manner. Among other things, the systems, methods, and devices of the present disclosure address challenges in the comparative techniques by utilizing an agentic framework. This framework greatly reduces interruptions in the user's workflow, greatly reduces instances of hallucination by the underlying AI models, and improves the tailoring of content to the user. Moreover, by apportioning certain components of the systems described herein in an agentic manner, consumption of resources (e.g., computing power, memory, electricity, and the like) is reduced by limiting the overall amount of resources that are invoked to handle similar problems, compared to the comparative implementations.

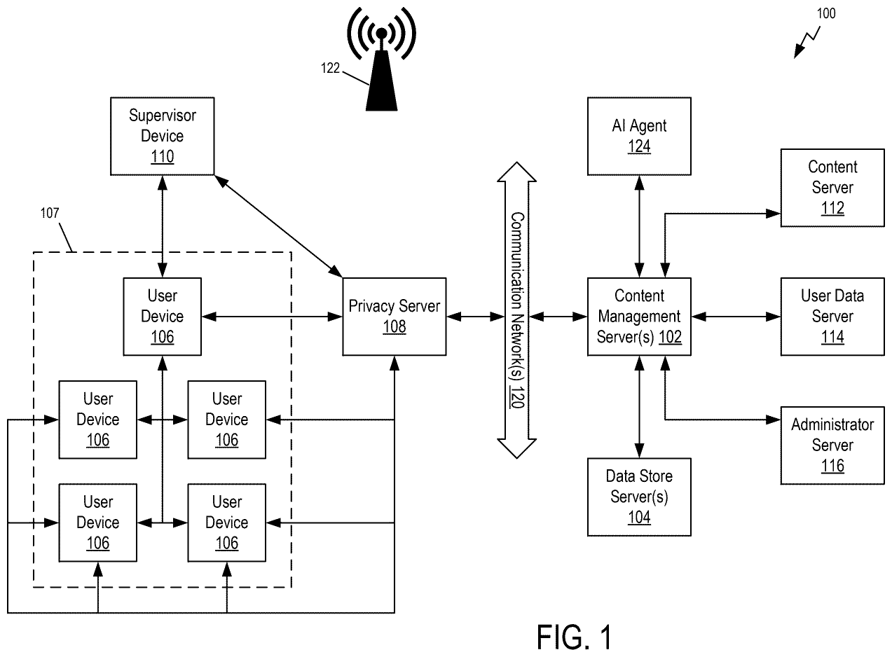

In some examples, the techniques described herein may be implemented with or by a content distribution network (CDN); for example, to gather underlying data, process it, or present it in an understandable manner. With reference now to FIG. 1, a block diagram is shown illustrating various components of a CDN 100 that implements and supports certain aspects and features described herein. In some aspects, the content distribution network 100 can comprise one or several physical components and/or one or several virtual components such as, for example, one or several cloud computing components. In some aspects, the content distribution network 100 can comprise a mixture of physical and cloud computing components.

Content distribution network 100 may include one or more content management servers 102. As discussed below in more detail, content management servers 102 may be any desired type of server including, for example, a rack server, a tower server, a miniature server, a blade server, a mini rack server, a mobile server, an ultra-dense server, a super server, or the like, and may include various hardware components, for example, a motherboard, a processing unit, memory systems, hard drives, network interfaces, power supplies, etc. Content management server 102 may include one or more server farms, clusters, or any other appropriate arrangement and/or combination of computer servers. Content management server 102 may act according to stored instructions located in a memory subsystem of the server 102, and may run an operating system, including any commercially available server operating system and/or any other operating systems discussed herein.

The content distribution network 100 may include one or more data store servers 104, such as database servers and file-based storage systems. The database servers 104 can access data that can be stored on a variety of hardware components. These hardware components can include, for example, components forming tier 0 storage, components forming tier 1 storage, components forming tier 2 storage, and/or any other tier of storage. In some embodiments, tier 0 storage refers to storage that is the fastest tier of storage in the database server 104, and particularly, the tier 0 storage is the fastest storage that is not RAM or cache memory. In some embodiments, the tier 0 memory can be embodied in solid state memory such as, for example, a solid-state drive (SSD) and/or flash memory.

In some aspects, the tier 1 storage refers to storage that is one or several higher performing systems in the memory management system, and that is relatively slower than tier 0 memory, and relatively faster than other tiers of memory. The tier 1 memory can be one or several hard disks that can be, for example, high-performance hard disks. These hard disks can be one or both of physically or communicatively connected such as, for example, by one or several fiber channels. In some embodiments, the one or several disks can be arranged into a disk storage system, and specifically can be arranged into an enterprise class disk storage system. The disk storage system can include any desired level of redundancy to protect data stored therein, and in one embodiment, the disk storage system can be made with grid architecture that creates parallelism for uniform allocation of system resources and balanced data distribution.

In some aspects, the tier 2 storage refers to storage that includes one or several relatively lower performing systems in the memory management system, as compared to the tier 1 and tier 2 storages. Thus, tier 2 memory is relatively slower than tier 1 and tier 0 memories. Tier 2 memory can include one or several SATA-drives or one or several NL-SATA drives.

In some aspects, the one or several hardware and/or software components of the database server 104 can be arranged into one or several storage area networks (SAN), which one or several storage area networks can be one or several dedicated networks that provide access to data storage, and particularly that provide access to consolidated, block level data storage. A SAN typically has its own network of storage devices that are generally not accessible through the local area network (LAN) by other devices. The SAN allows access to these devices in a manner such that these devices appear to be locally attached to the user device.

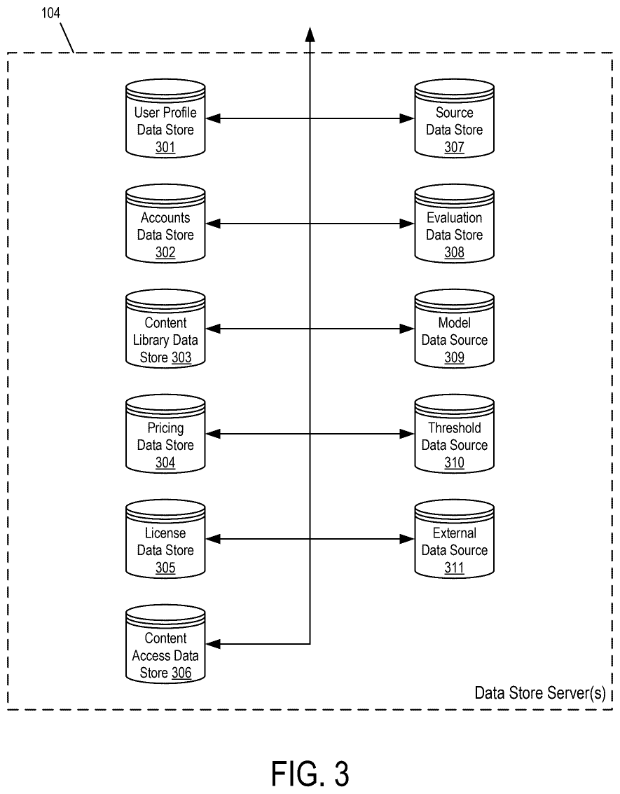

Data stores 104 may comprise stored data relevant to the functions of the content distribution network 100. Illustrative examples of data stores 104 that may be maintained in certain embodiments of the content distribution network 100 are described below in reference to FIG. 3. In some aspects, multiple data stores may reside on a single server 104, either using the same storage components of server 104 or using different physical storage components to assure data security and integrity between data stores. In other aspects, each data store may have a separate dedicated data store server 104.

Content distribution network 100 also may include one or more user devices 106 and/or supervisor devices 110. User devices 106 and supervisor devices 110 may display content received via the content distribution network 100, and may support various types of user interactions with the content. User devices 106 and supervisor devices 110 may include mobile devices such as smartphones, tablet computers, personal digital assistants, and wearable computing devices. Such mobile devices may run a variety of mobile operating systems, and may be enabled for Internet, e-mail, short message service (SMS), Bluetooth®, mobile radio-frequency identification (M-RFID), near-field communication (NFC), and/or other communication protocols. Other user devices 106 and supervisor devices 110 may be general purpose personal computers or special-purpose computing devices including, by way of example, personal computers, laptop computers, workstation computers, projection devices, and interactive room display systems. Additionally, user devices 106 and supervisor devices 110 may be any other electronic devices, such as thin-client computers, Internet-enabled gaming systems, business or home appliances, and/or personal messaging devices, capable of communicating over network(s) 120.

In different contexts of content distribution networks 100, user devices 106 and supervisor devices 110 may correspond to different types of specialized devices, for example, student devices and teacher devices in an educational network, employee devices and presentation devices in a company network, different gaming devices in a gaming network, etc. In some embodiments, user devices 106 and supervisor devices 110 may operate in the same physical location 107, such as a classroom or conference room. In such cases, the devices may contain components that support direct communications with other nearby devices, such as a wireless transceivers and wireless communications interfaces, Ethernet sockets or other LAN interfaces, etc. In other implementations, the user devices 106 and supervisor devices 110 need not be used at the same location 107, but may be used in remote geographic locations in which each user device 106 and supervisor device 110 may use security features and/or specialized hardware (e.g., hardware-accelerated Secure Socket Layer (SSL) and Secure Hypertext Transfer Protocol (HTTPS), WS-Security, firewalls, etc.) to communicate with the content management server 102 and/or other remotely-located user devices 106. Additionally, different user devices 106 and supervisor devices 110 may be assigned different designated roles, such as presenter devices, teacher devices, administrator devices, or the like, and in such cases the different devices may be provided with additional hardware and/or software components to provide content and support user capabilities not available to the other devices.

The content distribution network 100 also may include a privacy server 108 that maintains private user information at the privacy server 108 while using applications or services hosted on other servers. For example, the privacy server 108 may be used to maintain private data of a user within one jurisdiction even though the user is accessing an application hosted on a server (e.g., the content management server 102) located outside the jurisdiction. In such cases, the privacy server 108 may intercept communications between a user device 106 or supervisor device 110 and other devices that include private user information. The privacy server 108 may create a token or identifier that does not disclose the private information and may use the token or identifier when communicating with the other servers and systems, instead of using the user's private information.

As illustrated in FIG. 1, the content management server 102 may be in communication with one or more additional servers, such as a content server 112, a user data server 112, and/or an administrator server 116. Each of these servers may include some or all of the same physical and logical components as the content management server(s) 102, and in some cases, the hardware and software components of these servers 112-116 may be incorporated into the content management server(s) 102, rather than being implemented as separate computer servers.

Content server 112 may include hardware and software components to generate, store, and maintain the content resources for distribution to user devices 106 and other devices in the network 100. For example, in content distribution networks 100 used for professional training and educational purposes, content server 112 may include data stores of training materials, presentations, plans, syllabi, reviews, evaluations, interactive programs and simulations, course models, course outlines, and various training interfaces that correspond to different materials and/or different types of user devices 106. In content distribution networks 100 used for media distribution, interactive gaming, and the like, a content server 112 may include media content files such as music, movies, television programming, games, and advertisements.

User data server 114 may include hardware and software components that store and process data for multiple users relating to each user's activities and usage of the content distribution network 100. For example, the content management server 102 may record and track each user's system usage, including his or her user device 106, content resources accessed, and interactions with other user devices 106. This data may be stored and processed by the user data server 114, to support user tracking and analysis features. For instance, in the professional training and educational contexts, the user data server 114 may store and analyze each user's training materials viewed, presentations attended, courses completed, interactions, evaluation results, and the like. The user data server 114 may also include a repository for user-generated material, such as evaluations and tests completed by users, and documents and assignments prepared by users. In the context of media distribution and interactive gaming, the user data server 114 may store and process resource access data for multiple users (e.g., content titles accessed, access times, data usage amounts, gaming histories, user devices and device types, etc.).

Administrator server 116 may include hardware and software components to initiate various administrative functions at the content management server 102 and other components within the content distribution network 100. For example, the administrator server 116 may monitor device status and performance for the various servers, data stores, and/or user devices 106 in the content distribution network 100. When necessary, the administrator server 116 may add or remove devices from the network 100, and perform device maintenance such as providing software updates to the devices in the network 100. Various administrative tools on the administrator server 116 may allow authorized users to set user access permissions to various content resources, monitor resource usage by users and devices 106, and perform analyses and generate reports on specific network users and/or devices (e.g., resource usage tracking reports, training evaluations, etc.).

The content distribution network 100 may include one or more communication networks 120. Although only a single network 120 is identified in FIG. 1, the content distribution network 100 may include any number of different communication networks between any of the computer servers and devices shown in FIG. 1 and/or other devices described herein. Communication networks 120 may enable communication between the various computing devices, servers, and other components of the content distribution network 100. As discussed below, various implementations of content distribution networks 100 may employ different types of networks 120, for example, computer networks, telecommunications networks, wireless networks, and/or any combination of these and/or other networks.

The content distribution network 100 may include one or several navigation systems or features including, for example, the Global Positioning System (“GPS”), GALILEO, or the like, or location systems or features including, for example, one or several transceivers that can determine location of the one or several components of the content distribution network 100 via, for example, triangulation. All of these are depicted as navigation system 122.

In some embodiments, navigation system 122 can include one or several features that can communicate with one or several components of the content distribution network 100 including, for example, with one or several of the user devices 106 and/or with one or several of the supervisor devices 110. In some embodiments, this communication can include the transmission of a signal from the navigation system 122 which signal is received by one or several components of the content distribution network 100 and can be used to determine the location of the one or several components of the content distribution network 100.

The content distribution network 100 may include one or several artificial intelligence agents 124, also referred to herein as an AI agent 124, intelligence agent 124, and IA agent 124. The AI agent 124 can be an autonomous entity that can receive inputs via one or several sensors or from one or several user devices and can provide responses to those received inputs. In some embodiments, the AI agent 124 can comprise a question answering computing system, all or portions of an intelligent task framework system, pedagogical agent, or the like. In some embodiments, the functioning of the AI agent 124 can be predicated upon artificial intelligence, generative artificial intelligence, machine learning, LLMs, or the like. The AI agent 124 can reside in the server 102 and/or another component of the content distribution network 100, or can reside on a separate server or on separate computing resources. The AI agent 124 can be configured to receive inputs from the user device 106. The AI agent 124 can further launch a dialogue based on the received inputs and identify a remediation dialogue based on the received user inputs. In some embodiments, the AI agent 124 can determine termination of the dialogue and/or the remediation dialogue based on a user performance metric indicative of a user skill level.

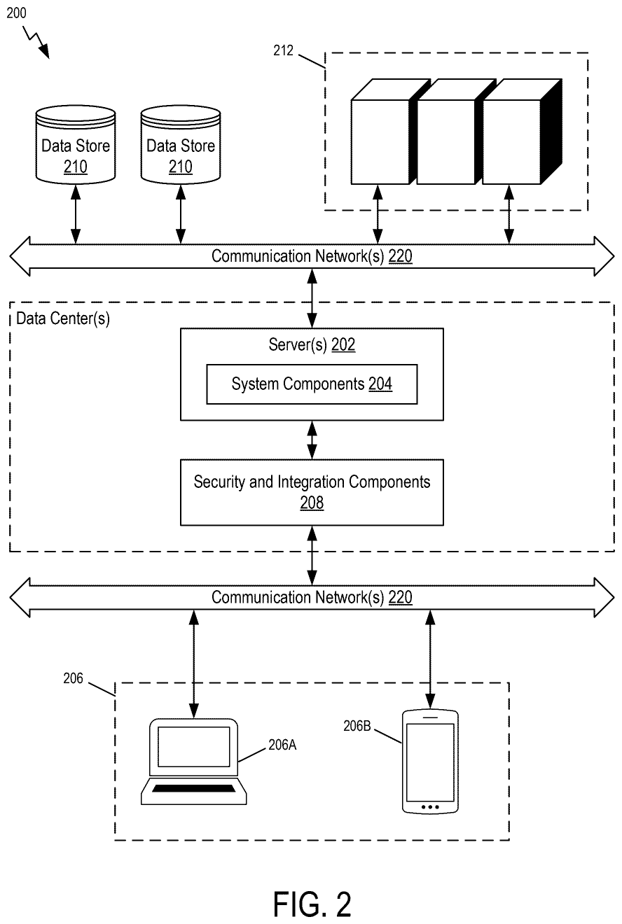

With reference to FIG. 2, an illustrative distributed computing environment 200 is shown. In some examples, the distributed computing environment 100 may include one or more computer servers 202 (e.g., data servers, computing devices, computers, etc.), one or more client computing devices 206, and other components that may implement certain aspects and features described herein. Although exemplary computing environment 200 is shown with two client computing devices 206, any number of client computing devices may be supported. In some implementations, the server 202 may correspond to the content management server 102 discussed above in FIG. 1, and the client computing devices 206 may correspond to the user devices 106. However, the computing environment 200 illustrated in FIG. 2 may correspond to any other combination of devices and servers configured to implement a client-server model or other distributed computing architecture.

Other devices, such as specialized sensor devices, etc., may interact with the client computing devices 206 and/or the servers 202. The servers 202, the client computing devices 206, or any other devices may be configured to implement a client-server model or any other distributed computing architecture. In some examples, the servers 202, the client computing devices 206, and any other disclosed devices may be communicatively coupled via one or more communication networks 220.

Client devices 206 may receive client applications from server 202 or from other application providers (e.g., public or private application stores). Server 202 may be configured to run one or more server software applications or services, for example, web-based or cloud-based services, to support content distribution and interaction with client devices 206. Users operating client devices 206 may in turn utilize one or more client applications (e.g., virtual client applications) to interact with server 202 to utilize the services provided by these components.

Various different subsystems and/or components 204 may be implemented on server 202. Users operating the client devices 206 may initiate one or more client applications to use services provided by these subsystems and components. The subsystems and components within the server 202 and client devices 206 may be implemented in hardware, firmware, software, or combinations thereof. Various different system configurations are possible in different distributed computing systems 200 and content distribution networks 100. The embodiment shown in FIG. 2 is thus one example of a distributed computing system and is not intended to be limiting.

As shown in FIG. 2, various security and integration components 208 may be used to send and manage communications between the server 202 and user devices 206 over one or more communication networks 220. The security and integration components 208 may include separate servers, such as web servers and/or authentication servers, and/or specialized networking components, such as firewalls, routers, gateways, load balancers, and the like. In some cases, the security and integration components 208 may correspond to a set of dedicated hardware and/or software operating at the same physical location and under the control of same entities as server 202. For example, components 208 may include one or more dedicated web servers and network hardware in a datacenter or a cloud infrastructure. In other examples, the security and integration components 208 may correspond to separate hardware and software components which may be operated at a separate physical location and/or by a separate entity.

Security and integration components 208 may implement various security features for data transmission and storage, such as authenticating users and restricting access to unknown or unauthorized users. In various implementations, security and integration components 208 may provide, for example, a file-based integration scheme or a service-based integration scheme for transmitting data between the various devices in the content distribution network 100. Security and integration components 208 also may use secure data transmission protocols and/or encryption for data transfers, for example, File Transfer Protocol (FTP), Secure File Transfer Protocol (SFTP), and/or Pretty Good Privacy (PGP) encryption.

In some embodiments, one or more web services may be implemented within the security and integration components 208 and/or elsewhere within the content distribution network 100. Such web services, including cross-domain and/or cross-platform web services, may be developed for enterprise use in accordance with various web service standards, such as RESTful web services (i.e., services based on the Representation State Transfer (REST) architectural style and constraints), and/or web services designed in accordance with the Web Service Interoperability (WS-I) guidelines. Some web services may use the SSL or Transport Layer Security (TLS) protocol to provide secure connections between the server 202 and user devices 206. SSL or TLS may use HTTP or HTTPS to provide authentication and confidentiality. In other examples, web services may be implemented using REST over HTTPS with the OAuth open standard for authentication, or using the WS-Security standard which provides for secure SOAP messages using XML encryption. In other examples, the security and integration components 208 may include specialized hardware for providing secure web services. For example, security and integration components 208 may include secure network appliances having built-in features such as hardware-accelerated SSL and HTTPS, WS-Security, and firewalls. Such specialized hardware may be in-stalled and configured in front of any web servers, so that any external devices may communicate directly with the specialized hardware.

The communication networks 220 may be any type of network known in the art supporting data communication. As examples, network 220 may be a LAN (e.g., Ethernet, Token-Ring, etc.), a wide-area network (WAN; e.g., the Internet), an infrared or wireless network, a public switch telephone network (PSTN), a virtual network, etc. The network 220 may use any available protocols, including but not limited to transmission control protocol/Internet protocol (TCP/IP), systems network architecture (SNA), Internet packet exchange (IPX), SSL, Transport Layer Security (TLS), HTTP, HTTPS, Institute of Electrical and Electronics (IEEE) 802.11 protocol suite or other wireless protocols, and the like.

Computing environment 200 also may include one or more data stores 210 and/or backend servers 212. In certain examples, the data stores 210 may correspond to data store server(s) 104 discussed above in FIG. 1, and back-end servers 212 may correspond to the various backend servers 112-116. Data stores 210 and servers 212 may reside in the same datacenter or may operate at a remote location from server 202. In some cases, one or more data stores 210 may reside on a non-transitory storage medium within the server 202. Other data stores 210 and back-end servers 212 may be remote from server 202 and configured to communicate with server 202 via one or more networks 220. In certain embodiments, data stores 210 and back-end servers 212 may reside in a SAN, or may use storage-as-a-service (STaaS) architectural model.

With reference to FIG. 3, an illustrative set of data stores and/or data store servers is shown, corresponding to the data store servers 104 of the content distribution network 100 discussed above in FIG. 1. One or more individual data stores 301-311 may reside in storage on a single computer server 104 (or a single server farm or cluster) under the control of a single entity, or may reside on separate servers operated by different entities and/or at remote locations. In some embodiments, data stores 301-311 may be accessed by the content management server 102 and/or other devices and servers within the network 100 (e.g., user devices 106, supervisor devices 110, administrator servers 116, etc.). Access to one or more of the data stores 301-311 may be limited or denied based on the processes, user credentials, and/or devices attempting to interact with the data store.

The paragraphs below describe examples of specific data stores that may be implemented within some embodiments of a content distribution network 100. It should be under-stood that the below descriptions of data stores 301-311, including their functionality and types of data stored therein, are illustrative and non-limiting. Data stores server architecture, design, and the execution of specific data stores 301-311 may depend on the context, size, and functional requirements of a content distribution network 100. For example, in content distribution systems 100 used for professional training and educational purposes, separate databases or file-based storage systems may be implemented in data store server(s) 104 to store trainee and/or student data, trainer and/or professor data, training module data and content descriptions, training results, evaluation data, and the like. In contrast, in content distribution systems 100 used for media distribution from content providers to subscribers, separate data stores may be implemented in data stores server(s) 104 to store listings of available content titles and descriptions, content title usage statistics, subscriber profiles, account data, payment data, network usage statistics, etc.

A user profile data store 301, also referred to herein as a user profile database 301, may include information relating to the end users within the content distribution network 100. This information may include user characteristics such as the user names, access credentials (e.g., logins and passwords), user preferences, and information relating to any previous user interactions within the content distribution network 100 (e.g., requested content, posted content, content modules completed, training scores or evaluations, other associated users, etc.). In some aspects, this information can relate to one or several individual end users such as, for example, one or several students, teachers, administrators, or the like, and in some aspects, this information can relate to one or several institutional end users such as, for example, one or several schools, groups of schools such as one or several school districts, one or several colleges, one or several universi-ties, one or several training providers, or the like. In some aspects, this information can identify one or several user memberships in one or several groups such as, for example, a student's membership in a university, school, program, grade, course, class, or the like.

The user profile database 301 can include information relating to a user's status, location, or the like. This information can identify, for example, a device a user is using, the location of that device, or the like. In some aspects, this information can be generated based on any location detection technology including, for example, a navigation system 122, or the like.

Information relating to the user's status can identify, for example, logged-in status information that can indicate whether the user is presently logged-in to the content distribution network 100 and/or whether the log-in-is active. In some aspects, the information relating to the user's status can identify whether the user is currently accessing content and/or participating in an activity from the content distribution network 100.

In some aspects, information relating to the user's status can identify, for example, one or several attributes of the user's interaction with the content distribution network 100, and/or content distributed by the content distribution network 100. This can include data identifying the user's interactions with the content distribution network 100, the content consumed by the user through the content distribution network 100, or the like. In some aspects, this can include data identifying the type of information accessed through the content distribution network 100 and/or the type of activity performed by the user via the content distribution network 100, the lapsed time since the last time the user accessed content and/or participated in an activity from the content distribution network 100, or the like. In some aspects, this information can relate to a content program comprising an aggregate of data, content, and/or activities, and can identify, for example, progress through the content program, or through the aggregate of data, content, and/or activities forming the content program. In some aspects, this information can track, for example, the amount of time since participation in and/or completion of one or several types of activities, the amount of time since communication with one or several supervisors and/or supervisor devices 110, or the like.

In some aspects in which the one or several end users are individuals, and specifically are students, the user profile database 301 can further include information relating to these students' academic and/or educational history. This information can identify one or several courses of study that the student has initiated, completed, and/or partially completed, as well as grades received in those courses of study. In some embodiments, the student's academic and/or educational history can further include information identifying student performance on one or several tests, quizzes, and/or assignments. In some aspects, this information can be stored in a tier of memory that is not the fastest memory in the content delivery network 100.

The user profile database 301 can include information relating to one or several job seeker preferences. In some embodiments, for example, the user, also referred to herein as the job seeker or the seeker may have one or several preferred work preferences, one or several most effective work preferences, and/or the like. In some aspects, the job seeker's work preferences can be any preferences describing what type of position the job seeker operates best in or what type of position the job seeker prefers. In one aspect, these work preferences can include, for example, whether the job seeker prefers remote, hybrid, or in-office positions. In some aspects, the data identifying one or several seekers'work preferences can include data identifying a work preference based on the seeker's employment history. In some aspects, this information can be stored in a tier of memory that is not the fastest memory in the content delivery network 100.

In some aspects, the user profile data store 301 can further include information identifying one or several user skill levels. In some aspects, these one or several user skill levels can identify a skill level determined based on past performance by the user interacting with the content delivery network 100, and in some aspects, these one or several user skill levels can identify a predicted skill level determined based on past performance by the user interacting with the content delivery network 100 and one or several predictive models.

The user profile database 301 can further include information relating to one or several employers and/or representatives who are responsible for organizing, presenting, and/or managing the presentation of information to the seeker. In some aspects, user profile database 301 can include information identifying positions offered by the representatives, data identifying professional fields offered by the representatives, and/or data identifying positions that will be or are expected to be offered by the representatives. In some aspects, this can include information relating to one or several professions or one or several employers. In some aspects, the user profile database 301 can further include information indicating past evaluations and/or evaluation reports received by the representatives. In some aspects, the user profile database 301 can further include information relating to improvement suggestions received by the representative, training received by the representative, continuing education received by the representative, and/or the like. In some aspects, this information can be stored in a tier of memory that is not the fastest memory in the content delivery network 100.

An accounts data store 302, also referred to herein as an accounts database 302, may generate and store account data for different users in various roles within the content distribution network 100. For example, accounts may be created in an accounts data store 302 for individual end users, supervisors, administrator users, and entities such as companies or educational institutions. Account data may include account types, current account status, account characteristics, and any parameters, limits, restrictions associated with the accounts.

A content library data store 303, also referred to herein as a content library database 303, may include information describing the individual content items (or content resources or data packets) available via the content distribution network 100. In some aspects, these data packets in the content library database 303 can be linked to form an object network. In some aspects, these data packets can be linked in the object network according to one or several sequential relationship which can be, in some aspects, prerequisite relationships that can, for example, identify the relative hierarchy and/or difficulty of the data objects. In some aspects, this hierarchy of data objects can be generated by the content distribution network 100 according to user experience with the object network, and in some aspects, this hierarchy of data objects can be generated based on one or several existing and/or external hierarchies such as, for example, a syllabus, a table of contents, or the like. In some aspects, for example, the object network can correspond to a syllabus such that content for the syllabus is embodied in the object network.

In some aspects, the content library data store 303 can comprise a syllabus, a schedule, or the like. In some aspects, the syllabus or schedule can identify one or several tasks and/or events relevant to the user. In some aspects, for example, when the user is a member of a group such as a professional organization, these tasks and/or events relevant to the user can identify one or several aspects or contacts related to the professional organization.

In some aspects, the library data store 303 may include metadata, properties, and other characteristics associated with the content resources stored in the content server 112. Such data may identify one or more aspects or content attributes of the associated content resources, for example, subject matter, access level, or skill level of the content resources, license attributes of the content resources (e.g., any limitations and/or restrictions on the licensable use and/or distribution of the content resource), price attributes of the content resources (e.g., a price and/or price structure for determining a payment amount for use or distribution of the content resource), rating attributes for the content resources (e.g., data indicating the evaluation or effectiveness of the content resource), and the like. In some aspects, the library data store 303 may be configured to allow updating of content metadata or properties, and to allow the addition and/or removal of information relating to the content resources. For example, content relationships may be implemented as graph structures, which may be stored in the library data store 303 or in an additional store for use by selection algorithms along with the other metadata.

In some aspects, the content library data store 303 can contain information used in evaluating responses received from users. In some aspects, for example, a user can receive content from the content distribution network 100 and can, subsequent to receiving that content, provide a response to the received content. In some aspects, for example, the received content can comprise one or several questions, prompts, or the like, and the response to the received content can comprise an answer to those one or several questions, prompts, or the like. In some aspects, information, referred to herein as “comparative data,” from the content library data store 303 can be used to determine whether the responses are the correct and/or desired responses.

In some aspects, the content library database 303 and/or the user profile database 301 can comprise an aggregation network, also referred to herein as a content network or content aggregation network. The aggregation network can comprise a plurality of content aggregations that can be linked together by, for example: creation by common user; relation to a common subject, topic, skill, or the like; creation from a common set of source material such as source data packets; or the like. In some aspects, the content aggregation can comprise a grouping of content comprising the presentation portion that can be provided to the user in the form of, for example, a flash card and an extraction portion that can comprise the desired response to the presentation portion such as for example, an answer to a flash card. In some aspects, one or several content aggregations can be generated by the content distribution network 100 and can be related to one or several data packets that can be, for example, organized in object network. In some aspects, the one or several content aggregations can be each created from content stored in one or several of the data packets.

In some aspects, the content aggregations located in the content library database 303 and/or the user profile database 301 can be associated with a user-creator of those content aggregations. In some aspects, access to content aggregations can vary based on, for example, whether a user created the content aggregations. In some aspects, the content library database 303 and/or the user profile database 301 can comprise a database of content aggregations associated with a specific user, and in some aspects, the content library database 303 and/or the user profile database 301 can comprise a plurality of databases of content aggregations that are each associated with a specific user. In some aspects, these databases of content aggregations can include content aggregations created by their specific user and, in some aspects, these databases of content aggregations can further include content aggregations selected for inclusion by their specific user and/or a supervisor of that specific user. In some aspects, these content aggregations can be arranged and/or linked in a hierarchical relationship similar to the data packets in the object network and/or linked to the object network in the object network or the tasks or skills associated with the data packets in the object network or the syllabus or schedule.

In some aspects, the content aggregation network, and the content aggregations forming the content aggregation network can be organized according to the object network and/or the hierarchical relationships embodied in the object network. In some aspects, the content aggregation network, and/or the content aggregations forming the content aggregation network can be organized according to one or several tasks identified in the syllabus, schedule or the like.

A pricing data store 304 may include pricing information and/or pricing structures for determining payment amounts for providing access to the content distribution network 100 and/or the individual content resources within the network 100. In some cases, pricing may be determined based on a user's access to the content distribution network 100, for example, a time-based subscription fee, or pricing based on network usage. In other cases, pricing may be tied to specific content resources. Certain content resources may have associated pricing information, whereas other pricing determinations may be based on the resources accessed, the profiles and/or accounts of the user, and the desired level of access (e.g., duration of access, network speed, etc.). Additionally, the pricing data store 304 may include information relating to compilation pricing for groups of content resources, such as group prices and/or price structures for groupings of resources.

A license data store 305 may include information relating to licenses and/or licensing of the content resources within the content distribution network 100. For example, the license data store 305 may identify licenses and licensing terms for individual content resources and/or compilations of content resources in the content server 112, the rights holders for the content resources, and/or common or large-scale right holder information such as contact information for rights holders of content not included in the content server 112.

A content access data store 306 may include access rights and security information for the content distribution network 100 and specific content resources. For example, the content access data store 306 may include login information (e.g., user identifiers, logins, passwords, etc.) that can be verified during user login attempts to the network 100. The content access data store 306 also may be used to store assigned user roles and/or user levels of access. For example, a user's access level may correspond to the sets of content resources and/or the client or server applications that the user is permitted to access. Certain users may be permitted or denied access to certain applications and resources based on their subscription level, training program, supervisory level, etc. Certain users may have supervisory access over one or more end users, allowing the supervisor to access all or portions of the end user's content, activities, evaluations, etc. Additionally, certain users may have administrative access over some users and/or some applications in the content management network 100, allowing such users to add and remove user accounts, modify user access permissions, perform maintenance updates on software and servers, etc.

A source data store 307 may include information relating to the source of the content resources available via the content distribution network. For example, a source data store 307 may identify the authors and originating devices of content resources, previous pieces of data and/or groups of data originating from the same authors or originating devices, and the like.

An evaluation data store 308 may include information used to direct the evaluation of users and content resources in the content management network 100. In some aspects, the evaluation data store 308 may contain, for example, the analysis criteria and the analysis guidelines for evaluating users (e.g., trainees/students, gaming users, media content consumers, etc.) and/or for evaluating the content resources in the network 100. The evaluation data store 308 also may include information relating to evaluation processing tasks, for example, the identification of users and user devices 106 that have received certain content resources or accessed certain applications, the status of evaluations or evaluation histories for content resources, users, or applications, and the like. Evaluation criteria may be stored in the evaluation data store 308 including data and/or instructions in the form of one or several electronic rubrics or scoring guides for use in the evaluation of the content, users, or applications. The evaluation data store 308 also may include past evaluations and/or evaluation analyses for users, content, and applications, including relative rankings, characterizations, explanations, and the like.

A model data store 309, also referred to herein as a model database 309, can store information relating to one or several predictive models which predictive models can be, for example, statistical models. In some aspects, these can include one or several evidence models, risk models, skill models, or the like. In some aspects, an evidence model can be a mathematically-based statistical model. The evidence model can be based on, for example, Item Response Theory (IRT), Bayesian Network (Bayes net), Performance Factor Analysis (PFA), or the like. The evidence model can, in some aspects, be customizable to a user and/or to one or several content items. Specifically, one or several inputs relating to the user and/or to one or several content items can be inserted into the evidence model. These inputs can include, for example, one or several measures of user skill level, one or several measures of content item difficulty and/or skill level, or the like. The customized evidence model can then be used to predict the likelihood of the user providing desired or undesired responses to one or several of the content items.

In some aspects, the risk models can include one or several models that can be used to calculate one or several model function values. In some aspects, these one or several model function values can be used to calculate a risk probability, which risk probability can characterize the risk of a user such as a student-user failing to achieve a desired outcome such as, for example, failing to correctly respond to one or several data packets, failure to achieve a desired level of completion of a program, for example in a pre-defined time period, failure to achieve a desired learning outcome, or the like. In some aspects, the risk probability can identify the risk of the student-user failing to complete 60% of the program.

In some aspects, these models can include a plurality of model functions including, for example, a first model function, a second model function, a third model function, and a fourth model function. In some aspects, some or all of the model functions can be associated with a portion of the program such as, for example, a completion stage and/or completion status of the program. In one aspect, for example, the first model function can be associated with a first completion status, the second model function can be associated with a second completion status, the third model function can be associated with a third completion status, and the fourth model function can be associated with a fourth completion status. In some aspects, these completion statuses can be selected such that some or all of these completion statuses are less than the desired level of completion of the program. Specifically, in some aspects, these completion statuses can be selected to all be at less than 60% completion of the program, and more specifically, in some aspects, the first completion status can be at 20% completion of the program, the second completion status can be at 30% completion of the program, the third completion status can be at 40% completion of the program, and the fourth completion status can be at 50% completion of the program. Similarly, any desired number of model functions can be associated with any desired number of completion statuses.

In some aspects, a model function can be selected from the plurality of model functions based on a seeker's progress through a program (e.g., a training program). In some aspects, the seeker's progress can be compared to one or several status trigger thresholds, each of which status trigger thresholds can be associated with one or more of the model functions. If one of the status triggers is triggered by the seeker's progress, the corresponding one or several model functions can be selected.

The model functions can comprise a variety of types of models and/or functions. In some aspects, each of the model functions outputs a function value that can be used in calculating a risk probability. This function value can be calculated by performing one or several mathematical operations on one or several values indicative of one or several user attributes and/or user parameters, also referred to herein as program status parameters. In some aspects, each of the model functions can use the same program status parameters, and in some aspects, the model functions can use different program status parameters. In some aspects, the model functions use different program status parameters when at least one of the model functions uses at least one program status parameter that is not used by others of the model functions.

In some aspects, a skill model can comprise a statistical model identifying a predictive skill level of one or several job seekers. In some aspects, this model can identify a single skill level of a seeker and/or a range of possible skill levels of a seeker. In some aspects, this statistical model can identify a skill level of a seeker and an error value or error range associated with that skill level. In some aspects, the error value can be associated with a confidence interval determined based on a confidence level. Thus, in some aspects, as the number of interactions with the content distribution network increases, the confidence level can increase and the error value can decrease such that the range identified by the error value about the predicted skill level is smaller.

A threshold database 310, also referred to herein as a threshold database, can store one or several threshold values. These one or several threshold values can delineate between states or conditions. In one exemplary aspect, for example, a threshold value can delineate between an acceptable user performance and an unacceptable user performance, between content appropriate for a user and content that is inappropriate for a user, between risk levels, or the like.

In addition to the illustrative data stores described above, data store server(s) 104 (e.g., database servers, file-based storage servers, etc.) may include one or more external data aggregators 311. External data aggregators 311 may include third-party data sources accessible to the content management network 100, but not maintained by the content management network 100. External data aggregators 311 may include any electronic information source relating to the users, content resources, or applications of the content distribution network 100. For example, external data aggregators 311 may be third-party data stores containing demographic data, education-related data, consumer sales data, health-related data, and the like. Illustrative external data aggregators 311 may include, for example, social networking web servers, public records data stores, learning management systems, educational institution servers, business servers, consumer sales data stores, medical record data stores, etc. Data retrieved from various external data aggregators 311 may be used to verify and update user account information, suggest user content, and perform user and content evaluations.

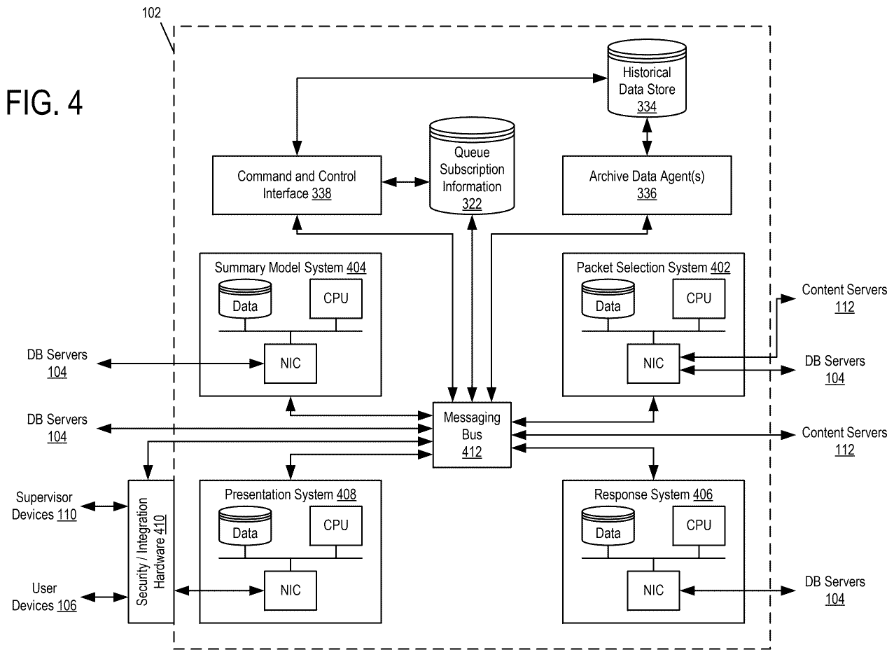

With reference now to FIG. 4, a block diagram is shown illustrating an aspect of one or more content management servers 102 within a content distribution network 100. In such an aspect, content management server 102 performs internal data gathering and processing of streamed content along with external data gathering and processing. Other aspects could have either all external or all internal data gathering. This aspect allows reporting timely information that might be of interest to the reporting party or other parties. In this aspect, the content management server 102 can monitor gathered information from several sources to allow it to make timely business and/or processing decisions based upon that information. For example, reports of user actions and/or responses, as well as the status and/or results of one or several processing tasks could be gathered and reported to the content management server 102 from a number of sources.

Internally, the content management server 102 gathers information from one or more internal components 402-408. The internal components 402-408 gather and/or process information relating to such things as: content provided to users; content consumed by users; responses provided by users; user skill levels; content difficulty levels; next content for providing to users; etc. The internal components 402-408 can report the gathered and/or generated information in real-time, near real-time or along another timeline. To account for any delay in reporting information, a time stamp or staleness indicator can inform others of how timely the information was sampled. The content management server 102 can opt to allow third parties to use internally or externally gathered information that is aggregated within the server 102 by subscription to the content distribution network 100.

A command and control (CC) interface 338 configures the gathered input information to an output of data streams, also referred to herein as content streams. APIs for accepting gathered information and providing data streams are provided to third parties external to the server 102 who want to subscribe to data streams. The server 102 or a third party can design as yet un-defined APIs using the CC interface 338. The server 102 can also define authorization and authentication parameters using the CC interface 338 such as authentication, authorization, login, and/or data encryption. CC information is passed to the internal components 402-408 and/or other components of the content distribution network 100 through a channel separate from the gathered information or data stream in this aspect, but other aspects could embed CC information in these communication channels. The CC information allows throttling information reporting frequency, specifying formats for information and data streams, deactivation of one or several internal components 402-408 and/or other components of the content distribution network 100, updating authentication and authorization, etc.

The various data streams that are available can be researched and explored through the CC interface 338. Those data stream selections for a particular subscriber, which can be one or several of the internal components 402-408 and/or other components of the content distribution network 100, are stored in the queue subscription information database 322. The server 102 and/or the CC interface 338 then routes selected data streams to processing subscribers that have selected delivery of a given data stream. Additionally, the server 102 also supports historical queries of the various data streams that are stored in an historical data store 334 as gathered by an archive data agent 336. Through the CC interface 238 various data streams can be selected for archiving into the historical data store 334.

Components of the content distribution network 100 outside of the server 102 can also gather information that is reported to the server 102 in real-time, near real-time or along another timeline. There is a defined API between those components and the server 102. Each type of information or variable collected by server 102 falls within a defined API or multiple APIs. In some cases, the CC interface 338 is used to define additional variables to modify an API that might be of use to processing subscribers. The additional variables can be passed to all processing sub-scribes or just a subset. For example, a component of the content distribution network 100 outside of the server 102 may report a user response but define an identifier of that user as a private variable that would not be passed to processing subscribers lacking access to that user and/or authorization to receive that user data. Processing subscribers having access to that user and/or authorization to receive that user data would receive the subscriber identifier along with response reported that component. Encryption and/or unique addressing of data streams or sub-streams can be used to hide the private variables within the messaging queues.

The user devices 106 and/or supervisor devices 110 communicate with the server 102 through security and/or integration hardware 410. The communication with security and/or integration hardware 410 can be encrypted or not. For example, a socket using a TCP connection could be used. In addition to TCP, other transport layer protocols like SCTP and UDP could be used in some aspects to intake the gathered information. A protocol such as SSL could be used to protect the information over the TCP connection. Authentication and authorization can be performed to any user devices 106 and/or supervisor device interfacing to the server 102. The security and/or integration hardware 410 receives the information from one or several of the user devices 106 and/or the supervisor devices 110 by providing the API and any encryption, authorization, and/or authentication. In some cases, the security and/or integration hardware 410 reformats or rearranges this received information.

The messaging bus 412, also referred to herein as a messaging queue or a messaging channel, can receive information from the internal components of the server 102 and/or components of the content distribution network 100 outside of the server 102 and distribute the gathered information as a data stream to any processing subscribers that have requested the data stream from the messaging queue 412. As indicate in FIG. 4, processing subscribers are indicated by a connector to the messaging bus 412, the connector having an arrowhead pointing away from the messaging bus 412. Only data streams within the messaging queue 412 that a particular processing subscriber has subscribed to may be read by that processing subscriber if received at all. Gathered information sent to the messaging queue 412 is processed and returned in a data stream in a fraction of a second by the messaging queue 412. Various multi casting and routing techniques can be used to distribute a data stream from the messaging queue 412 that a number of processing subscribers have requested. Protocols such as Multicast or multiple Unicast could be used to distribute streams within the messaging queue 412. Additionally, transport layer protocols like TCP, SCTP and UDP could be used in various aspects.

Through the CC interface 338, an external or internal processing subscriber can be assigned one or more data streams within the messaging queue 412. A data stream is a particular type of message in a particular category. For example, a data stream can comprise all of the data reported to the messaging bus 412 by a designated set of components. One or more processing subscribers could subscribe and receive the data stream to process the information and make a decision and/or feed the output from the processing as gathered information fed back into the messaging queue 412. Through the CC interface 338 a developer can search the available data streams or specify a new data stream and its APL The new data stream might be determined by processing a number of existing data streams with a processing subscriber.

The CDN 110 has internal processing subscribers 402-408 that process assigned data streams to perform functions within the server 102. Internal processing subscribers 402-408 could perform functions such as providing content to a user, receiving a response from a user, determining the correctness of the received response, updating one or several models based on the correctness of the response, recommending new content for providing to one or several users, or the like. The internal processing subscribers 402-408 can decide filtering and weighting of records from the data stream. To the extent that decisions are made based upon analysis of the data stream, each data record is time stamped to reflect when the information was gathered such that additional credibility could be given to more recent results, for example. Other aspects may filter out records in the data stream that are from an unreliable source or stale. For example, a particular contributor of information may prove to have less than optimal gathered information and that could be weighted very low or removed altogether.

Internal processing subscribers 402-408 may additionally process one or more data streams to provide different information to feed back into the messaging queue 412 to be part of a different data stream. For example, hundreds of user devices 106 could provide responses that are put into a data stream on the messaging queue 412. An internal processing subscriber 402-408 could receive the data stream and process it to determine the difficulty of one or several data packets provided to one or several users, and supply this information back onto the messaging queue 412 for possible use by other internal and external processing subscribers.

As mentioned above, the CC interface 338 allows the CDN 110 to query historical messaging queue 412 information. An archive data agent 336 listens to the messaging queue 412 to store data streams in a historical database 334. The historical database 334 may store data streams for varying amounts of time and may not store all data streams. Different data streams may be stored for different amounts of time.

With regard to the components 402-48, the content management server(s) 102 may include various server hardware and software components that manage the content resources within the content distribution network 100 and provide interactive and adaptive content to users on various user devices 106. For example, content management server(s) 102 may provide instructions to and receive information from the other devices within the content distribution network 100, in order to manage and transmit content resources, user data, and server or client applications executing within the network 100.

A content management server 102 may include a packet selection system 402. The packet selection system 402 may be implemented using dedicated hardware within the content distribution network 100 (e.g., a packet selection server 402), or using designated hardware and software resources within a shared content management server 102. In some aspects, the packet selection system 402 may adjust the selection and adaptive capabilities of content resources to match the needs and desires of the users receiving the content. For example, the packet selection system 402 may query various data stores and servers 104 to retrieve user information, such as user preferences and characteristics (e.g., from a user profile data store 301), user access restrictions to content recourses (e.g., from a content access data store 306), previous user results and content evaluations (e.g., from an evaluation data store 308), and the like. Based on the retrieved information from data stores 104 and other data sources, the packet selection system 402 may modify content resources for individual users.

In some aspects, the packet selection system 402 can include a recommendation engine, also referred to herein as an adaptive recommendation engine. In some aspects, the recommendation engine can select one or several pieces of content, also referred to herein as data packets, for providing to a user. These data packets can be selected based on, for example, the information retrieved from the database server 104 including, for example, the user profile database 301, the content library database 303, the model database 309, or the like. In some aspects, these one or several data packets can be adaptively selected and/or selected according to one or several selection rules. In one aspect, for example, the recommendation engine can retrieve information from the user profile database 301 identifying, for example, a skill or experience level of the user. The recommendation engine can further retrieve information from the content library database 303 identifying, for example, potential data packets for providing to the user and the difficulty of those data packets and/or the skill level associated with those data packets.

The recommendation engine can identify one or several potential data packets for providing and/or one or several data packets for providing to the user based on, for example, one or several rules, models, predictions, or the like. The recommendation engine can use the skill level of the user to generate a prediction of the likelihood of one or several users providing a desired response to some or all of the potential data packets. In some aspects, the recommendation engine can pair one or several data packets with selection criteria that may be used to determine which packet should be delivered to a student-user based on one or several received responses from that student-user. In some aspects, one or several data packets can be eliminated from the pool of potential data packets if the prediction indicates either too high a likelihood of a desired response or too low a likelihood of a desired response. In some aspects, the recommendation engine can then apply one or several selection criteria to the remaining potential data packets to select a data packet for providing to the user. These one or several selection criteria can be based on, for example, criteria relating to a desired estimated time for receipt of response to the data packet, one or several content parameters, one or several assignment parameters, or the like.

A content management server 102 also may include a summary model system 404. The summary model system 404 may be implemented using dedicated hardware within the content distribution network 100 (e.g., a summary model server 404), or using designated hardware and software resources within a shared content management server 102. In some aspects, the summary model system 404 may monitor the progress of users through various types of content resources and groups, such as media compilations, courses or curriculums in training or educational contexts, interactive gaming environments, and the like. For example, the summary model system 404 may query one or more databases and/or data store servers 104 to retrieve user data such as associated content compilations or programs, content completion status, user goals, results, and the like.

A content management server 102 also may include a response system 406, which can include, in some aspects, a response processor. The response system 406 may be implemented using dedicated hardware within the content distribution network 100 (e.g., a response server 406), or using designated hardware and software resources within a shared content management server 102. The response system 406 may be configured to receive and analyze information from user devices 106. For example, various ratings of content resources submitted by users may be com-piled and analyzed, and then stored in a data store (e.g., a content library data store 303 and/or evaluation data store 308) associated with the content. In some aspects, the response server 406 may analyze the information to determine the effectiveness or appropriateness of content resources with, for example, a subject matter, an age group, a skill level, or the like. In some aspects, the response system 406 may provide updates to the packet selection system 402 or the summary model system 404, with the attributes of one or more content resources or groups of resources within the network 100. The response system 406 also may receive and analyze user evaluation data from user devices 106, supervisor devices 110, and administrator servers 116, etc. For instance, response system 406 may receive, aggregate, and analyze user evaluation data for different types of users (e.g., end users, supervisors, administrators, etc.) in different contexts (e.g., media consumer ratings, trainee or student comprehension levels, teacher effectiveness levels, gamer skill levels, etc.).

In some aspects, the response system 406 can be further configured to receive one or several responses from the user and analyze these one or several responses. In some aspects, for example, the response system 406 can be configured to translate the one or several responses into one or several observables. As used herein, an observable is a characterization of a received response. In some aspects, the translation of the one or several responses into one or several observables can include determining whether the one or several responses are correct responses, also referred to herein as desired responses, or are incorrect responses, also referred to herein as undesired responses. In some aspects, the translation of the one or several responses into one or several observables can include characterizing the degree to which one or several responses are desired responses and/or undesired responses. In some aspects, one or several values can be generated by the response system 406 to reflect user performance in responding to the one or several data packets. In some aspects, these one or several values can comprise one or several scores for one or several responses and/or data packets.

A content management server 102 also may include a presentation system 408. The presentation system 408 may be implemented using dedicated hardware within the content distribution network 100 (e.g., a presentation server 408), or using designated hardware and software resources within a shared content management server 102. The presentation system 408 can include a presentation engine that can be, for example, a software module running on the content delivery system.

The presentation system 408, also referred to herein as the presentation module or the presentation engine, may receive content resources from the packet selection system 402 and/or from the summary model system 404, and provide the resources to user devices 106. The presentation system 408 may determine the appropriate presentation format for the content resources based on the user characteristics and preferences, and/or the device capabilities of user devices 106. If needed, the presentation system 408 may convert the content resources to the appropriate presentation format and/or compress the content before transmission. In some aspects, the presentation system 408 may also determine the appropriate transmission media and communication protocols for transmission of the content resources.

In some aspects, the presentation system 408 may include specialized security and integration hardware 410, along with corresponding software components to implement the appropriate security features content transmission and storage, to provide the supported network and client access models, and to support the performance and scalability requirements of the network 100. The security and integration layer 410 may include some or all of the security and integration components 208 discussed above in FIG. 2, and may control the transmission of content resources and other data, as well as the receipt of requests and content interactions, to and from the user devices 106, supervisor devices 110, administrative servers 116, and other devices in the network 100.

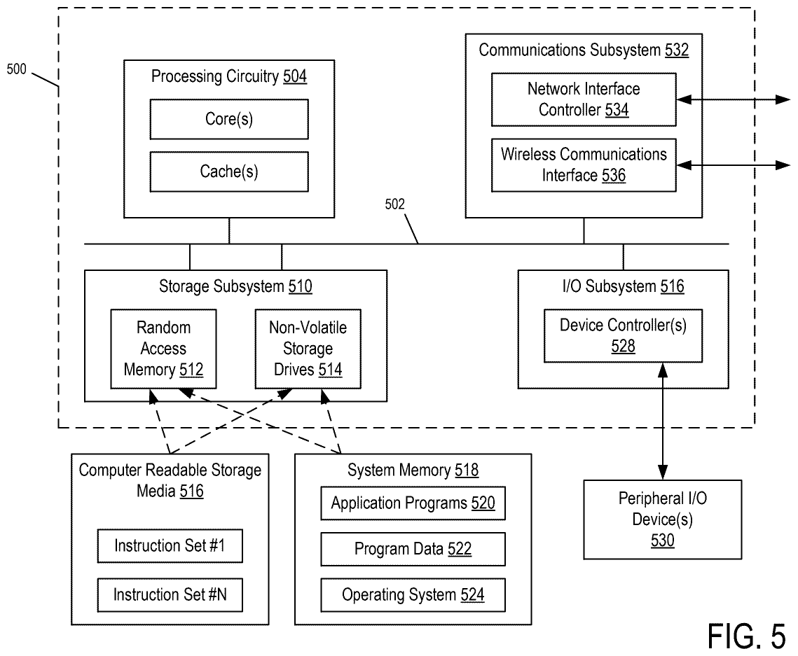

With reference now to FIG. 5, a block diagram of an example computing system 500 is shown. The computing system 500 (e.g., one or more computers) may correspond to any one or more of the computing devices or servers of the distribution computing environment 200, or any other computing devices described herein. In an example, the computing system 500 may represent an example of one or more servers 202 and/or of one or more servers 212 of the distribution computing environment 200. In another example, the computing system 500 may represent an example of the client computing devices 206 of the distribution computing environment 200. In some examples, the computing system 500 may represent a combination of one or more computing devices and/or servers of the distribution computing environment 200.

In some examples, the computing system 500 may include processing circuitry 504, such as one or more processing unit(s), processor(s), etc. In some examples, the processing circuitry 504 may communicate (e.g., interface) with a number of peripheral subsystems via a bus subsystem 502. These peripheral subsystems may include, for example, a storage subsystem 510, an input/output (I/O) subsystem 526, and a communications subsystem 532.

In some examples, the computing system 500 may include processing circuitry 504, such as one or more processing units, processors, etc. In some examples, the processing circuitry 504 may communicate (e.g., interface) with a number of peripheral subsystems via a bus subsystem 502. These peripheral subsystems may include, for example, a storage subsystem 510, an input/output (I/O) subsystem 526, and a communications subsystem 532.

In some examples, the bus subsystem 502 provides a mechanism for intended communication between the various components and subsystems of computing system 500. Although the bus subsystem 502 is shown schematically as a single bus, alternative embodiments of the bus subsystem may utilize multiple buses. In some examples, the bus subsystem 502 may include a memory bus, memory controller, peripheral bus, and/or local bus using any of a variety of bus architectures (e.g., Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

In some examples, the I/O subsystem 526 may include one or more device con-troller(s) 528 for one or more user interface input devices and/or user interface output devices, possibly integrated with the computing system 500 (e.g., integrated audio/video systems, and/or touchscreen displays), or may be separate peripheral devices which are attachable/detachable from the computing system 500. Input may include keyboard or mouse input, audio input (e.g., spoken commands), motion sensing, gesture recognition (e.g., eye gestures), etc. As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like. In general, use of the term “output device” is intended to include all possible types of devices and mechanisms for out-putting information from computing system 500, such as to a user (e.g., via a display device) or any other computing system, such as a second computing system 500. In an example, output devices may include one or more display subsystems and/or display devices that visually convey text, graphics and audio/video information (e.g., cathode ray tube (CRT) displays, flat-panel devices, liquid crystal display (LCD) or plasma display devices, organic light emitting display (OLED) devices, projection devices, touch screens, etc.), and/or may include one or more non-visual display subsystems and/or non-visual display devices, such as audio output devices, etc. As non-limiting examples, output devices may include, indicator lights, monitors, printers, speakers, headphones, automotive navigation systems, plotters, voice output devices, modems, etc.

In some examples, the computing system 500 may include one or more storage subsystems 510, including hardware and software components used for storing data and program instructions, such as system memory 518 and computer-readable storage media 516. In some examples, the system memory 518 and/or the computer-readable storage media 516 may store and/or include program instructions that are loadable and executable on the processor(s) 504. In an example, the system memory 518 may load and/or execute an operating system 524, program data 522, server applications, application program(s) 520 (e.g., client applications), Internet browsers, mid-tier applications, etc. In some examples, the system memory 518 may further store data generated during execution of these instructions.

In some examples, the system memory 518 may be stored in volatile memory (e.g., random-access memory (RAM) 512, including static random-access memory (SRAM) or dynamic random-access memory (DRAM)). In an example, the RAM 512 may contain data and/or program modules that are immediately accessible to and/or operated and executed by the processing circuitry 504. In some examples, the system memory 518 may also be stored in non-volatile storage drives 514 (e.g., read-only memory (ROM), flash memory, etc.). In an example, a basic input/output system (BIOS), containing the basic routines that help to transfer information between elements within the computing system 500 (e.g., during start-up), may typically be stored in the non-volatile storage drives 514.

In some examples, the storage subsystem 510 may include one or more tangible computer-readable storage media 516 for storing the basic programming and data constructs that provide the functionality of some embodiments. In an example, the storage subsystem 510 may include software, programs, code modules, instructions, etc., that may be executed by the processing circuitry 504, in order to provide the functionality described herein. In some examples, data generated from the executed software, programs, code, modules, or instructions may be stored within a data storage repository within the storage subsystem 510. In some examples, the storage subsystem 510 may also include a computer-readable storage media reader connected to the computer-readable storage media 516.

In some examples, the computer-readable storage media 516 may contain program code, or portions of program code. Together and, optionally, in combination with the system memory 518, the computer-readable storage media 516 may comprehensively represent remote, local, fixed, and/or removable storage devices plus storage media for temporarily and/or more permanently containing, storing, transmitting, and/or retrieving computer-readable information. In some examples, the computer-readable storage media 516 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer-readable media. This can also include non-tangible computer-readable media, such as data signals, data transmissions, or any other medium which can be used to transmit the desired information and which can be accessed by the computing system 500. In an illustrative and non-limiting example, the computer-readable storage media 516 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media.

In some examples, the computer-readable storage media 516 may include, but is not limited to, Zip® drives, flash memory cards, universal serial bus (USB) flash drives, secure digital (SD) cards, DVD disks, digital video tape, and the like. In some examples, the computer-readable storage media 516 may include, solid-state drives (SSD) based on non-volatile memory such as flash-memory based SSDs, enterprise flash drives, solid state ROM, and the like, SSDs based on volatile memory such as solid-state RAM, dynamic RAM, static RAM, DRAM-based SSDs, magneto-resistive RAM (MRAM) SSDs, and hybrid SSDs that use a combination of DRAM and flash memory-based SSDs. The disk drives and their associated computer-readable media may provide non-volatile storage of computer-readable instructions, data structures, program modules, and other data for the computing system 500.

In some examples, the communications subsystem 532 may provide a communication interface from the computing system 500 and external computing devices via one or more communication networks, LANs, WANs (e.g., the Internet), and various wireless telecommunications networks. As illustrated in FIG. 5, the communications subsystem 532 may include, for example, one or more network interface controllers (NICs) 534, such as Ethernet cards, Asynchronous Transfer Mode NICs, Token Ring NICs, and the like, as well as one or more wireless communications interfaces 536, such as wireless network interface controllers (WNICs), wireless network adapters, and the like. Additionally, and/or alternatively, the communications subsystem 532 may include one or more modems (telephone, satellite, cable, ISDN), synchronous or asynchronous digital subscriber line (DSL) units, Fire Wire® interfaces, USB® interfaces, and the like. Communications subsystem 532 also may include radio frequency (RF) transceiver components for accessing wireless voice and/or data networks (e.g., using cellular telephone technology, advanced data network technology, such as 3G, 4G, 5G or EDGE (enhanced data rates for global evolution), Wi-Fi (IEEE 802.11 family standards, or other mobile communication technologies, or any combination thereof), global positioning system (GPS) receiver components, and/or other components.

In some examples, the communications subsystem 532 may also receive input communication in the form of structured and/or unstructured data feeds, event streams, event updates, and the like, on behalf of one or more users who may use or access the computing system 500. In an example, the communications subsystem 532 may be configured to receive data feeds in real-time from users of social networks and/or other communication services, web feeds such as Rich Site Summary (RSS) feeds, and/or real-time updates from one or more third party information sources (e.g., data aggregators). Additionally, the communications subsystem 532 may be configured to receive data in the form of continuous data streams, which may include event streams of real-time events and/or event updates (e.g., sensor data applications, financial tickers, network performance measuring tools, clickstream analysis tools, automobile traffic monitoring, etc.). In some examples, the communications subsystem 532 may output such structured and/or unstructured data feeds, event streams, event updates, and the like to one or more data stores that may be in communication with one or more streaming data source computing systems (e.g., one or more data source computers, etc.) coupled to the computing system 500. The various physical components of the communications subsystem 532 may be detachable components coupled to the computing system 500 via a computer network (e.g., a communication network 220), a FireWire® bus, or the like, and/or may be physically integrated onto a motherboard of the computing system 500. In some examples, the communications subsystem 532 may be implemented in whole or in part by software.

Due to the ever-changing nature of computers and networks, the description of the computing system 500 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

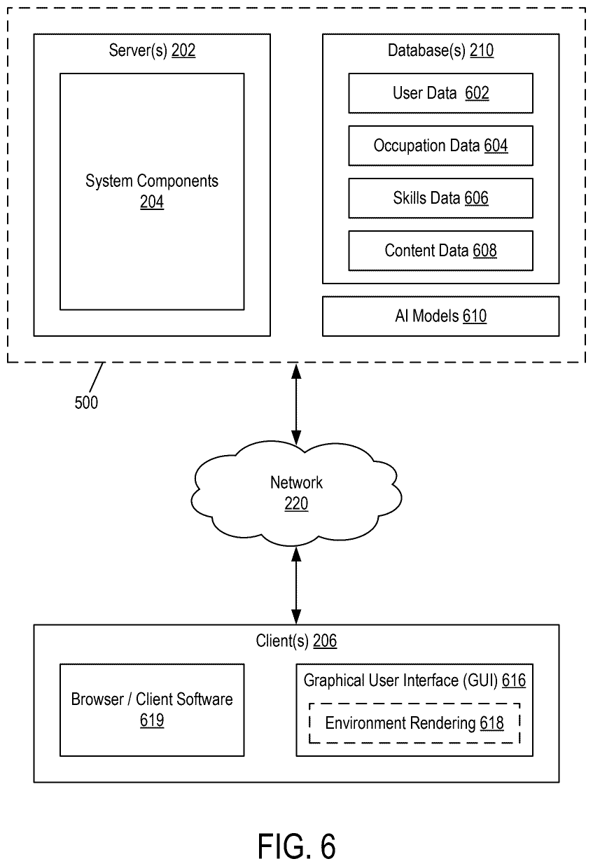

FIG. 6 illustrates a system level block diagram of a task framework system 600, such as a system for providing the disclosed artificial intelligence-based skilling methodologies according to some examples. In some examples, such as where the system 600 is configured to provide individualized and/or customized content, the system 600 may include one or more databases 210, also referred to as data stores herein. The databases 210 may include a plurality of user data 602 (e.g., a set of user data items). In such examples, the system 600 may store and/or manage the user data 602 in accordance with one or more of the various techniques of the disclosure. In some examples, the user data 602 may include user responses, user history, user scores, user performance, user preferences, and the like. In some examples, the system 600 may collect and aggregate some or all user data points from various sources (e.g., platforms, a worker response assessment component, a personalization component, a practice generation component, etc.) to determine characteristics regarding the user. The characteristics regarding the user may be stored in the database 210. In further examples, the characteristics regarding the user may be received by other sources (e.g., third-party components). Database 210 may further store user data 602 about each of one or more workers, possibly enrolled in a class or an organization, and stored as a worker profile for each of the workers. In some embodiments, this data, at a high level, may derive data from a high level for a plurality dimensions and characteristics associated with each of the workers.

As non-limiting examples, this user data 602 regarding each worker may include data derived from, for example, employment histories, credentials, assessments, and/or other information. In some aspects, this data may include content from a previous position or assessment submitted by the worker. In some aspects, this data may include identification of fields or positions for which the worker believes he or she is qualified, possibly associated in database 210 with a current or previous position or assessment. In some embodiments, this data may include additional data derived by determining a worker's interactions and/or results associated with one or more employment preferences stored in the database 210.

Furthermore, the database 210 may include occupation data 604. In some examples, the occupation data 604 may include information related to a skills ontology and job task analysis for various occupations. That is, the occupation data 604 may include information indicative of tasks that are typically performed in a given occupation, skills that are beneficial or necessary to perform the tasks, skills that employers value in the given occupation, and the like. The occupation data 604 may include data obtained from public sources, such as O*NET database information promulgated by the U.S. Department of Labor; data from proprietary sources, such as an internal database of job-related information; or combinations thereof. The occupation data 604 may be generated or augmented by one or more AI models, such as AI models 608 described in more detail below.

The database 210 may include skills data 606 indicative of a skill level of the worker, credentials possessed by the worker, the worker's accomplishments, and the like. In some examples, the skills data 606 may provide information related to a verified identity of the credential earner, criteria related to the credential itself (e.g., level, type of learning experience, success criteria for earning the credential, etc.), skills earned by the holder of the credential (e.g., by mapping criteria related to the credential to the occupation data 604), and the like.

The database 210 may also include content data 608. The content data 608 may include learning products or services, assessment products or services, or any other data that may be used (e.g., presented to the user) to enhance skilling and accelerate productivity gains across an enterprise. The content data 608 may include content corresponding to multiple learning modalities to drive worker engagement, such as self-study, short courses, videos, simulations, practice labs, assessments, or virtual live training. The content data 608 may be portioned into micro-assessments, including “bite-size” presentations or evaluations that are intended to be completed by the worker in a relatively short time period (e.g., five minutes or less). In examples, the content data 608 may include information to integrate the micro-assessments into an existing interface running on the client device 206, such that the worker does not need to leave the application environment that he or she is already using. The content data 608 may include generalized content that is applicable to the worker regardless of occupation or role, particularized content that relates to role-specific skills, and the like.

The system 500 may additionally include one or more AI models 610. In some examples, the AI models 610 can include generative AI models (e.g., LLMs and the like); machine learning models (e.g., recurrent neural networks (RNNs), convolutional neural networks (CNNs), deep learning models, transformer models, and the like); sequence-to-sequence models; word embeddings; memory networks; graph neural networks, or any other suitable artificial intelligence model. In further examples, the artificial intelligence models 610 can be stored in a remote or cloud server, which is communicatively coupled to the system server 202 over the network 220.

While FIG. 6 illustrates the database 210 as affirmatively including several different components (e.g., 602-608), this is merely exemplary and not limiting. In implementations, the database 210 may omit one or more of the components 602-608 if such components are not used, referenced, or implicated by the system 500. Moreover, while FIG. 6 illustrates certain dimensions of data as exemplified by components 602-608, in other implementations additional data dimensions may be implemented.

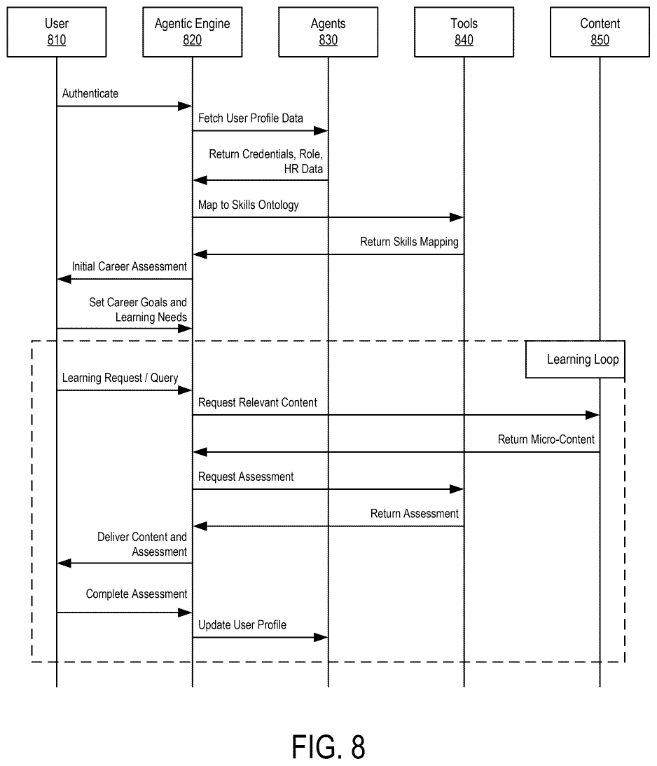

In some aspects of the present disclosure, the server 202 in coordination with the databases 210 may configure the system components 204 (e.g., AI models 610, which may be stored in the databases 210) for various functions, including, e.g., those described in more detail below with regard to FIGS. 8-10. The system components 204 may, in some examples, be implemented by an electronic processor of the server 202 (e.g., processing circuitry 504 of FIG. 5) executing instructions stored and retrieved from a memory of the server 202 (e.g., storage subsystem 510, computer readable storage media 516, and/or system memory 518 of FIG. 5).

In some examples, the system 500 may interact with the client computing device(s) 206 via one or more communication networks 220. In some examples, the client computing device(s) 206 can include a GUI 616 to render and/or display environments 618 (e.g., dynamic skilling/assessment environments, text entry windows, etc.) for the user. In some examples, the GUI 616 may be generated in part by execution by the client computing device 206 of browser/client software 619 based on data received from the system 500 via the network 220.

For example, the system 500 may be configured as an agentic skilling system. In such an implementation, the system 500 includes a memory (e.g., as one of the system components 204 and/or as part of the database 210) and a processor (e.g., as one of the system components 204) coupled with the memory. The processor may be configured to execute instructions stored in the memory or stored elsewhere, thereby to cause the system 500 to perform various operations. The operations may include any one or more of the operations described below, for example with regard to FIGS. 8-110. The processor may be said to “generate” or “present” certain elements (e.g., GUI elements) if the processor itself creates the element (e.g., by running one or more engines) or if the processor issues instructions to an external device (e.g., the client 206) to create the element. The data ingested or output by the system 500 may be in one or more file formats, including open-source and proprietary formats. The data may include plain text or rich text in one or more for-matting languages, including TeX, LaTeX, HyperText Markup Language (HTML), JavaScript Object Notation (JSON), and the like. These operations are merely exemplary, and the system 500 may be configured to perform any of the operations illustrated in FIG. 8-10, discussed in more detail below.

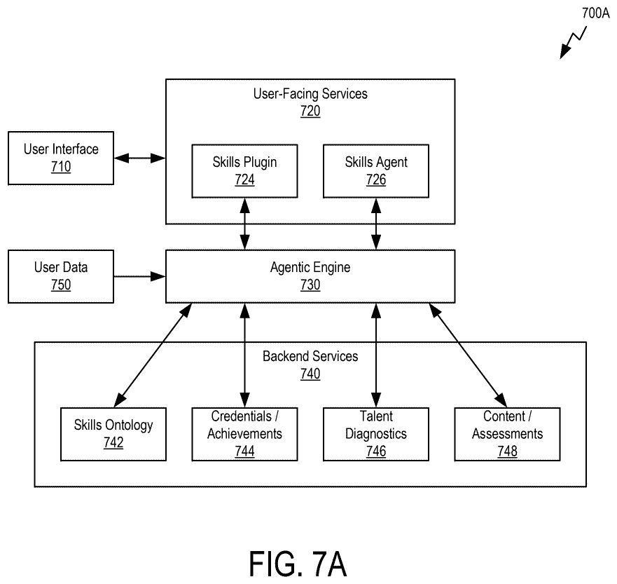

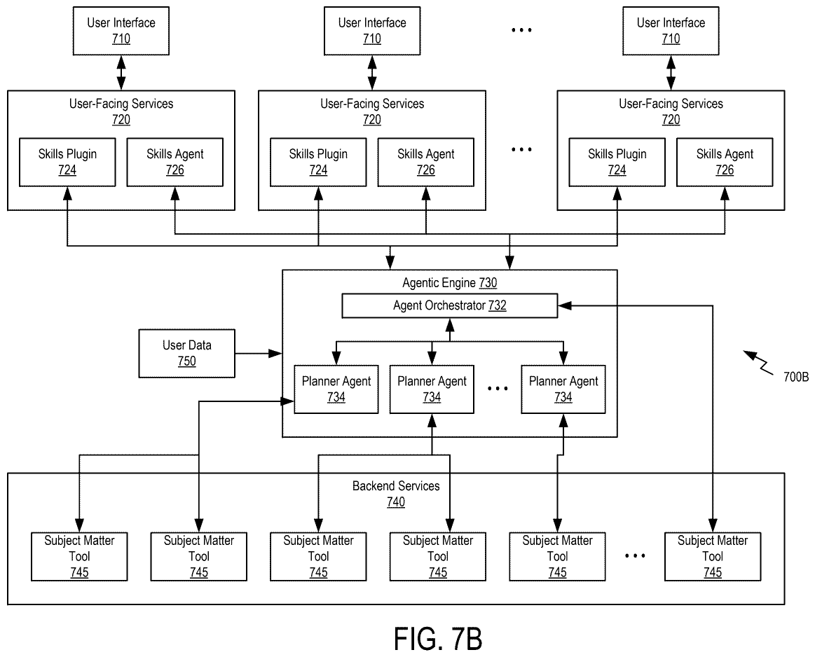

FIG. 7A illustrates one example of an agentic skilling system 700A. As illustrated, the system 700A includes a user interface 710 (e.g., a GUI presented on a user device), user-facing services 720, an agentic engine 730, a set of backend services 740, and a user data repository 750.

The user interface 710 may be or include an informational window presented on a user device, and provide components using which the user may interact with the remaining elements of the system 700A. For example, the user interface 710 may be or include a GUI element presented within an application running on the user device. The application may be a standalone interface application in some examples; however, in other examples the application may be implemented as a plug-in within another application that is used for another purpose, such as a work task that the user performs in his or her daily usage (e.g., a word processing application, a spreadsheet application, a presentation application, a web browser, etc.).

The user-facing services 720 may include an application or application plug-in configured to provide for interactions between the user and one or more services, such as AI services. The user-facing services 720 may include components that reside within the user device (e.g., a web browser, a virtual assistant, etc.) or components that reside within a remote device (e.g., server-or cloud-based components). In one example, the user-facing services 720 may be a generative text-based service that provides for “conversational” communication with the user, such as an LLM-based service. The user-facing services 720 include a skills plugin 724 and a skills agent 726 through which the user-facing services 720 may interface with the agentic engine 730.

The agentic engine 730 provides an agentic interface between the user-facing services 720 and the backend services 740. In examples, the agentic engine 730 may include an orchestrator component to communicate with the user-facing services 720 (e.g., via the skills plugin 724 or the skills agent 726) and a planner component to communicate with the backend services 740. The planner component may, for example, receive a stream of communication and related context from the orchestrator component, determine an appropriate endpoint from among the backend services 740 for the stream (for example, by parsing the stream to determine which of the backend services 740 should be invoked), and routing the stream or portions thereof (along with any relevant context) to the appropriate backend service 740.

The backend services 740 may include a plurality of individual subject-matter specific services. The backend services 740 include, in the illustrated example, services directed to a skills ontology 742, credentials and achievements 744, talent diagnostics 746, and content and assessments 748. The skills ontology services 742 may include a service for managing (e.g., storing, updating, retrieving, transmitting, evaluating, etc.) information related to skills and occupations. For example, a portion of the skills ontology services 742 may be configured to extract skills relevant to a user, while another portion of the skills ontology services 742 may be configured to identify information relevant to an occupation associated with the user. The occupation information may include skills that are relevant to the occupation, prevalence information for the occupation, trends in the prevalence of information or skills for the occupation, and the like.

The credentials and achievements service 744 may include a service for managing (e.g., storing, updating, retrieving, transmitting, evaluating, etc.) information related to credentials or achievements relevant to the user. For example, the credentials and achievements service 744 may include a database of badges (or other indicators of achievement) that have been received or have yet to be received by the user. In examples, the credentials and achievements service 744 may include components to generate the badges themselves (e.g., using AI) or to recommend badges for the user.

The talent diagnostics service 746 may include a service for managing (e.g., storing, updating, retrieving, transmitting, evaluating, etc.) information related to skills that the user should have. This information may identify skills that are relevant to the user's role or occupation, skills necessary for promotion or growth of the user, and the like. In some examples, the talent diagnostics service 746 may identify goals for the user.

The content and assessments service 748 may include a service for managing (e.g., storing, updating, retrieving, transmitting, evaluating, etc.) information related to content or assessments (e.g., micro-assessments) that are available for completion by the user or have already been completed by the user. For example, the content and assessments service 748 may store a list of available evaluations, a list of evaluations completed by the user, a list of evaluations not yet completed by the user, and the like. The content and assessments service 748 may further include source content (e.g., courses, books, etc.) from which the evaluations are drawn. In some examples, the evaluations may be pre-generated and stored; however, in other examples, the evaluations may be generated as needed from the source content (e.g., using AI).

The agentic engine 730 may also be configured to retrieve user data 750. The user data 750 may include authentication information, user profile data, user evaluation data, user role data, existing credentials, user history data, data relating to the user device, and the like. The above-described architecture of system 700A is presented by way of example and not limitation. Generally, because the system 700A is an agentic system, it is scalable and flexible, for example by adding or removing agents. Thus, more, fewer, or different user interfaces 710, user-facing services 720, backend services 740 may be present.

FIG. 7B illustrates another example of an agentic skilling system 700B. In the example of FIG. 7B, certain elements correspond to the same elements as in FIG. 7A and thus are accorded the same reference numeral. For these elements, a detailed description is not repeated. However, it should be noted that, as shown in FIG. 7B, multiple copies or instances of various components may be present in the system, even where FIG. 7A illustrates only a single copy or instance. For example, the system 700B may interact with the user via multiple user interfaces 710, through multiple user-facing services 720, and the like. While FIG. 7B illustrates the user interfaces 710 and user-facing services 720 being present in a one-to-one arrangement, in practical implementations the user may interact with multiple user-facing services 720 via the same user interface 710 (e.g., to invoke different AI models using a single interface), may interact with a single user-facing service 720 via multiple interfaces 710 (e.g., to invoke the same AI model in different programs), or combinations thereof.

In the system 700B, the agent orchestrator 732 and a set of planner agents 734 are expressly illustrated. In this configuration, the agent orchestrator 732 receives input from the user via the user interface(s) 710 and allocates it to subject matter-specific planner agents 734. The individual planner agents 734 interface with one or more of a set of subject matter tools 745 in the backend services 740 to retrieve or provide the appropriate content. In this manner, the subject matter tools 745 may include the services 742, 744, 746, or 748 illustrated in FIG. 7B. In some instances, the agent orchestrator 732 may interface with a subject matter tool 745 directly.

In one specific example, a user may interact with the system 700B via a user interface 710 using a user-facing service 720 in the form of an LLM. The input is provided to the agentic engine 730. For example, the agent orchestrator 732 may parse the input and any associated context invoke one or more planner agents 734 accordingly. The planner agents 734 may include agents directed to tools, agents directed to content, and agents directed to other agents. For example, the agent orchestrator 732, based on the input, may invoke ontology or assessment tools, communicate with a credentials agent (which in turn invokes sub-agents related to received or recommended credentials) or an occupational agent (which in turn invokes sub-agents related to occupational mapping or associated skills), or retrieve information from a content database (which itself may include agents to generate or organize content). The agentic engine 730 may further store information related to the user, the user input, or responses received from the subject matter tools 745. Using the stored or received information, the agentic engine 730 may return one or more responses to the user, including text responses, micro-assessments, and the like.

In an example use case of the systems of FIG. 7A or 7B, a user may be working in a program on his or her device to perform data analytics task. The user may suspect that a particular data analytics methodology (e.g., a Monte Carlo simulation), and enter an inquiry into a text box in a user interface associated with (e.g., embedded in) the program. This inquiry may be received by an LLM-based user service, which is then routed to an agentic engine. The agentic engine parses the inquiry and determines that information from a content agent and an occupations agent would be relevant to the inquiry. For example, the agentic engine may invoke the occupations agent to determine how relevant the methodology is to the field of data analytics, and invoke the content agent to retrieve information relevant to the methodology (such as explanations, examples, tasks, assessments, etc.). The agentic engine may then organize the information received from the agents and cause it to be presented to the user via the interface.

By invoking different agents (each of which may be specialized to a particular task or field), the information returned to the user is more relevant to the user inquiry. Moreover, by presenting the information to the user in the same application and interface that he or she is working in, the user does not leave the flow of the tool. Thus, compared to comparative techniques, the user is more likely to invoke the agentic system and is more likely to benefit from the responses. In general, the systems discussed herein provide for ultra-personalized content that is presented within a single contained ecosystem. Thus, for enterprise users, for example, the skilling process is greatly improved. Moreover, through the user of an agent framework, the system has the flexibility to handle a much wider range of inputs that the comparative examples and has the scalability to provide utility in a much wider range of enterprise structures than the comparative example.

FIG. 8 illustrates an example of a communication flow between a user 810 and various components of the agentic skilling system, including an agentic engine 820, one or more agents 830, one or more tools 840, and one or more content stores 850. In examples, the user 810 may correspond to the user interface 710 of FIGS. 7A and 7B along with any associated devices or services (e.g., the user-facing services 720); the agentic engine 820 may correspond to the agentic engine 730 of FIGS. 7A and 7B; and the agents 830, tools 840, and content stores 850 may correspond to elements of the backend services 740 of FIGS. 7A and 7B. FIG. 8 illustrates communication flows for two procedures: an initial interfacing procedure (e.g., upon user log-in, user account creation, etc.), and a learning loop.

In the initial interfacing procedure, the user 810 sends an authentication request to the agentic engine 820. The authentication request may be a log-in request initiated by the user 810, or may be an automatic request generated by a user device (e.g., upon device startup). The agentic engine 820 then requests user profile data from an appropriate one of the agents 830, which returns the relevant information. In this case, the agent 830 returns user credentials, a user role (e.g., occupation), and various human resources data. Using this returned information, the agentic engine 820 sends a request to an appropriate one of the tools 840 to map the user data to a skills ontology. The tool 840 performs the mapping and returns an indication of the skills mapping. Using this information as well as the user data, the agentic engine generates an initial career assessment (e.g., a learning plan) and returns it to the user 810. The user 810 may respond by setting career goals and learning needs or desires, which are provided to the agentic engine 820.

At some point, the user 810 may desire to initiate a skilling process or the skilling process may be initiated by an organization that employs the user 810. In some instances, the skilling process may automatically initiate, for example if it is determined that the user 810 is having difficulty with a particular concept. The learning request or query is provided to the agentic engine 820, which requests the corresponding content items from a content store 850. The request may include an express identification of a content item, or may simply include an end goal used by the content store 850 to determine the appropriate content items. Then, the content store 850 returns the content (e.g., micro-content) to the agentic engine 820. Based on the content, the agentic engine 820 requests an assessment from an appropriate one of the tools 840. The tool 840 returns the assessment (e.g., a micro-assessment. The agentic engine 820 organizes the content and the assessment and delivers them to the user 810. For example, the agentic engine 820 may first present the user 810 with the content in the form of a lesson, and then present the user 810 with the assessment to be completed once the lesson has been finished. The user 810 completes the assessment, and the agentic agent 820 updates the profile in an appropriate agent 830 accordingly.

The learning loop may be repeated any number of times, either in immediate succession or at a later point. By invoking the agents 830, tools 840, and content 850, the agentic engine 820 ensures that the information provided to the user 810 is ultra-personalized and greatly reduces the instances of hallucinations or other problems that plague comparative tools. Moreover, because the agentic engine 820 organizes communications between the user 810 and the backend services, the user 810 does not need to leave the working environment (e.g., need not open a separate program) to partake of the skilling process. Thus, the system may be embedded in existing work or daily habit tools (such as an office communication program).

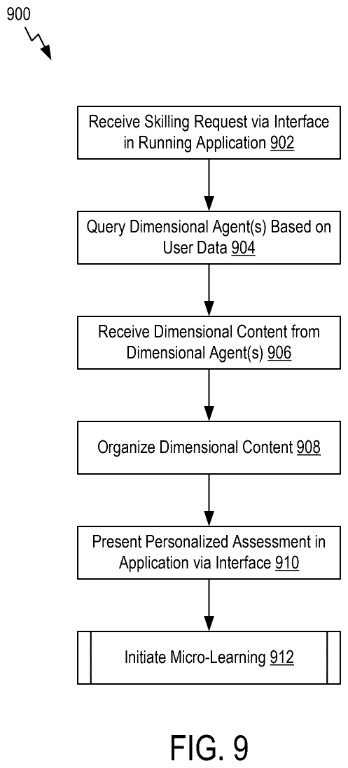

FIG. 9 illustrates one example implementation of the agentic skilling framework described above, including a method 900 for skilling. The method 900 may be implemented by any of the devices or systems described above. For example, the various operations of the method 900 may be performed by an electronic processor of any of the above devices or systems. The method 900 may correspond to, for example, the initial interfacing procedure of FIG. 8. For purposes of explanation, FIG. 9 will be described from the perspective of an agentic AI engine operating in an agentic skilling system, which includes a memory and at least one processor operatively connected to the memory and configured to perform the operations of FIG. 9.

The method 900 includes an operation 902 of receiving a skilling request via a user interface operating in an existing application on a user device. If the user interface is not open, operation 902 may include an operation of causing the user device to open the interface (e.g., an agentic interface) within the existing application without exiting the application. The skilling request may correspond to an initial assessment request to determine initial career goals or learning needs of a user of the user device. At operation 904, the agentic AI engine queries one or more dimensional agents (e.g., subject matter specific agents) based on the skilling request and on user data associated with the user. In examples, the dimensional agents include agents, tools, or content, and respectively correspond to different components of the skilling request or the skilling procedure. In particular, the dimensional agents may include one or more of an occupation agent corresponding to a set of relationships between occupations and skills; an assessment agent corresponding to a capability assessment; a credentials agent corresponding to one or more credentials, certifications, or achievements; a course agent corresponding to one or more learning courses; or a license agent corresponding to one or more training licenses.

Generally, the dimensional agents may be any one or more of the tools associated with backend services 740 illustrated in FIGS. 7A and 7B. Referring to FIG. 8, operation 902 may include requesting user profile data or requesting a mapping of data to a skills ontology. In some examples, operation 902 may include parsing the skilling request by the agentic AI engine to generate a plurality of context items (e.g., receiving context included within the skilling request, and selectively allocating among the dimensional agents), and may include providing corresponding contents items to the dimensional agents. Thus, a given agent does not receive more context than necessary (and is less likely to hallucinate or over-consume resources).

The agentic AI engine receives a plurality of dimensional content items from the plurality of dimensional agents at operation 906. Referring to FIG. 8, operation 904 may include receiving credentials, role data, human resources data, skill mapping data, and the like. At operation 908, the agentic AI engine organizes the received dimensional content. For example, the agentic AI engine may synthesize skill information received from one agent with occupational trend information received from another agent.

At operation 910, the agentic AI engine causes the user interface in the existing application on the user device to present the organized information to the user, for example in the form of a personalized assessment. Referring to FIG. 8, operation 910 may include presenting an initial career assessment. Operation 910 may be performed using the same interface by which the skilling request of operation 902 is received, thus permitting use without exiting the application. If the information includes an assessment, the user may provide a response that is received by the agentic AI engine, at which point the agentic AI engine may update the user data based on the response. For example, the agentic AI engine may update (or instruct another entity to update) a career goal or learning need associated with the user.

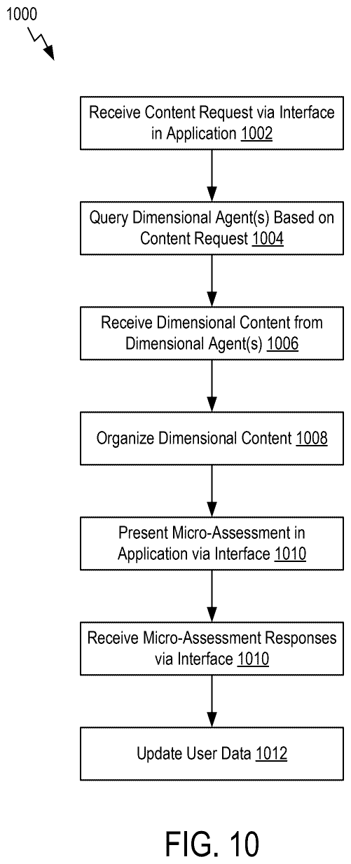

At a later point, which may be immediately following operation 910 or at another much later time, a micro-learning operation 912 may be initiated. FIG. 10 illustrates one example implementation of the micro-learning operation 912, corresponding to a method 1000. As with the method 900, the method 1000 may be implemented by any of the devices or systems described above. For example, the various operations of the method 1000 may be performed by an electronic processor of any of the above devices or systems. The method 1000 may correspond to, for example, the learning loop procedure of FIG. 8. For purposes of explanation, FIG. 10 will be described from the perspective of the same agentic AI engine used to perform the method 900.

The method 1000 includes an operation 1002 of receiving a content request via a user interface operating in an existing application on a user device. If the user interface is not open, operation 1002 may include an operation of causing the user device to open the interface (e.g., an agentic interface) within the existing application without exiting the application. The content request may correspond to a request for learning materials or assessments. The content request may be originated by the user, may be originated by another entity within the enterprise organization (e.g., a supervisor), or may be automatically initiated (e.g., on startup or log-in). In examples, operation 1002 corresponds to the learning request/query illustrated in FIG. 8.

At operation 1004, the agentic AI engine queries one or more dimensional agents (e.g., subject matter specific agents) based on the content request and on user data associated with the user. As above, the dimensional agents may include agents, tools, or content, and respectively correspond to different components of the skilling request or the skilling procedure. In particular, the dimensional agents may include one or more of an occupation agent corresponding to a set of relationships between occupations and skills; an assessment agent corresponding to a capability assessment; a credentials agent corresponding to one or more credentials, certifications, or achievements; a course agent corresponding to one or more learning courses; or a license agent corresponding to one or more training licenses.

As also noted above, the dimensional agents may be any one or more of the tools associated with backend services 740 illustrated in FIGS. 7A and 7B. Referring to FIG. 8, operation 1002 may include requesting relevant content or requesting an assessment. In some examples, operation 1002 may include parsing the content request by the agentic AI engine to generate a plurality of context items (e.g., receiving context included within the content request, and selectively allocating among the dimensional agents), and may include providing corresponding content items to the dimensional agents. Thus, a given agent does not receive more context than necessary (and is less likely to hallucinate or over-consume resources).

The agentic AI engine receives a plurality of dimensional content items from the plurality of dimensional agents at operation 1006. Referring to FIG. 8, operation 1004 may include receiving micro-content or an assessment. At operation 1008, the agentic AI engine organizes the received dimensional content. For example, the agentic AI engine may organize the presentation of information such that content is presented first, followed by an assessment.

At operation 1010, the agentic AI engine causes the user interface in the existing application on the user device to present the organized information to the user, for example in the form of content relevant to the request followed by a personalized assessment. Referring to FIG. 8, operation 1010 may include delivering content and an assessment. Operation 1010 may be performed using the same interface by which the skilling request of operation 1002 is received, thus permitting use without exiting the application. If the information includes an assessment, the user may provide a response that is received by the agentic AI engine, at which point the agentic AI engine may update the user data based on the response. For example, the agentic AI engine may update (or instruct another entity to update) a career goal or learning need associated with the user.

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such aspects or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its aspects.

What is claimed is:

1. An agentic skilling system, comprising:
a memory; and
at least one processor operatively connected to the memory, and configured to perform operations comprising:
receiving, by an agentic artificial intelligence (AI) engine, a skilling request via a user interface operating in an existing application on a user device;
querying, by the agentic AI engine, a plurality of dimensional agents based on the skilling request and a user data associated with a user of the user device, wherein respective ones of the plurality of dimensional agents correspond to different components of the skilling request;
receiving, by the agentic AI engine, a plurality of dimensional content items from the plurality of dimensional agents;
organizing, by the agentic AI engine, the plurality of dimensional content items into a personalized assessment; and
presenting, by the agentic AI engine, the personalized assessment via the user interface.

2. The system of claim 1, wherein the dimensional agents include at least one of: an occupation agent corresponding to a set of relationships between occupations and skills; an assessment agent corresponding to a capability assessment; a credentials agent corresponding to one or more credentials, certifications, or achievements; a course agent corresponding to one or more learning courses; or a license agent corresponding to one or more training licenses.

3. The system of claim 1, wherein the operation of querying includes, by the agentic AI engine:
parsing the skilling request to generate a plurality of context items; and
providing a respective one of the plurality of context items to a corresponding one of the plurality of dimensional agents.

4. The system of claim 1, the operations further comprising causing the user device to generate an agentic interface within the existing application without exiting the existing application.

5. The system of claim 4, wherein the operation of presenting the personalized assessment occurs via the agentic interface without exiting the existing application.

6. The system of claim 1, the operations further comprising:
receiving, by the agentic AI engine, a response to the personalized assessment via the user interface; and
updating the user data based on the response.

7. The system of claim 6, wherein the operation of updating the user data includes associating a credential with the user.

8. An agentic skilling method, comprising:
receiving, by an agentic artificial intelligence (AI) engine, a skilling request via a user interface operating in an existing application on a user device;
querying, by the agentic AI engine, a plurality of dimensional agents based on the skilling request and a user data associated with a user of the user device, wherein respective ones of the plurality of dimensional agents correspond to different components of the skilling request;
receiving, by the agentic AI engine, a plurality of dimensional content items from the plurality of dimensional agents;
organizing, by the agentic AI engine, the plurality of dimensional content items into a personalized assessment; and
presenting, by the agentic AI engine, the personalized assessment via the user interface.

9. The method of claim 8, wherein the dimensional agents include at least one of: an occupation agent corresponding to a set of relationships between occupations and skills; an assessment agent corresponding to a capability assessment; a credentials agent corresponding to one or more credentials, certifications, or achievements; a course agent corresponding to one or more learning courses; or a license agent corresponding to one or more training licenses.

10. The method of claim 8, wherein the operation of querying includes, by the agentic AI engine:
parsing the skilling request to generate a plurality of context items; and
providing a respective one of the plurality of context items to a corresponding one of the plurality of dimensional agents.

11. The method of claim 8, the operations further comprising causing the user device to generate an agentic interface within the existing application without exiting the existing application.

12. The method of claim 11, wherein the operation of presenting the personalized assessment occurs via the agentic interface without exiting the existing application.

13. The method of claim 8, the operations further comprising:
receiving, by the agentic AI engine, a response to the personalized assessment via the user interface; and
updating the user data based on the response.

14. The method of claim 13, wherein the operation of updating the user data includes associating a credential with the user.
